(19) United States
(12) Patent Application Publication
(10) Pub. No.: US 2015/0220967 A1
(43) Pub. Date: Aug. 6, 2015

(54) DELIVERY DEVICE, DELIVERY METHOD, FACILITY DEVICE, AND DELIVERY SYSTEM

(71) Applicant: YAHOO JAPAN CORPORATION, Tokyo (JP)

(72) Inventors: Yoshio IKAI, Tokyo (JP); Katsuhiko WAGA, Tokyo (JP)

(21) Appl. No.: 14/488,632

(22) Filed: Sep. 17, 2014

(30) Foreign Application Priority Data
Feb. 6, 2014 (JP) 2014-021788

(51) Int. Cl. G06Q 30/02

(52) U.S. Cl. CPC G06Q 30/0241

(57) ABSTRACT

A delivery device according to the present disclosure includes a providing unit and a delivering unit. The providing unit provides a sales service related to a space (for example, an advertisement space) of second content (for example, an advertisement) provided together with first content (for example, a movie) in a facility (for example, a movie theater) providing the first content. The delivering unit delivers associated information in which the second content corresponding to a right holder that has acquired a right related to the space in the sales service provided by the providing unit is associated with space information related to the space to the facility.

### CROSS-REFERENCE TO RELATED APPLICATIONS

The present application claims priority to and incorporates by reference the entire contents of Japanese Patent Application No. 2014-021788 filed in Japan on Feb. 6, 2014.

### BACKGROUND OF THE INVENTION

1. Field of the Invention

The present invention relates to a delivery device, a delivery method, a delivery program, a facility device, and a delivery system.

2. Description of the Related Art

Currently, content provided in facilities is often provided with an advertisement space in which an advertisement embedded before a main part of the content is screened. For example, in a movie theater, a few minutes of an advertisement space is set before a main part of a movie to be screened.

As a technique related to such advertisement delivery, a technique of scheduling a moving image and promotion content for viewers of a screening place is known. Specifically, in this technique, an advertisement provider is solicited to bid for a time slot in which promotion content is presented, an advertisement of an advertisement provider is associated with the time slot according to a received bid, and an advertisement is electronically acquired from the advertisement provider.

However, in the related art, an advertiser's burden is not expected to be necessarily reduced. Specifically, in the related art, a screening place to which an advertisement is delivered is limited. For this reason, when an advertiser desires to designate a condition such as a region or a delivery schedule and deliver an advertisement, the advertiser needs to purchase a time slot corresponding to a desired screening place, and thus an advertisement delivery procedure is complicated.

The present disclosure was made in light of the foregoing, and it is an object of the present disclosure to provide a delivery device, a delivery method, a delivery program, a facility device, and a delivery system, which are capable of reducing an advertiser's burden.

### SUMMARY OF THE INVENTION

According to the exemplary embodiment, a delivery device includes a providing unit configured to provide a sales service related to a space of second content provided together with first content in a facility providing the first content and a delivering unit configured to deliver associated information in which the second content corresponding to a right holder that has acquired a right related to the space in the sales service provided by the providing unit is associated with space information related to the space to the facility.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating an exemplary delivery process according to an embodiment;

FIG. 2 is a diagram illustrating an exemplary configuration of a delivery system according to an embodiment;

FIG. 3 is a diagram illustrating an exemplary configuration of an advertising device according to an embodiment;

FIG. 4 is a diagram illustrating an exemplary advertisement space storage unit according to an embodiment;

FIG. 5 is a diagram illustrating an exemplary advertisement content storage unit according to an embodiment;

FIG. 6 is a diagram illustrating an exemplary configuration of a movie theater device according to an embodiment;

FIG. 7 is a flowchart illustrating a provision process related to an advertisement space sales service performed by an advertising device according to an embodiment;

FIG. 8 is a flowchart illustrating a process of delivering advertisement space-associated information through an advertising device according to an embodiment;

FIG. 9 is a diagram illustrating an exemplary advertisement space storage unit according to a modified example;

FIG. 10 is a diagram illustrating an exemplary advertisement content storage unit according to a modified example;

FIG. 11 is a diagram illustrating an exemplary delivery process according to a modified example;

FIG. 12 is a diagram illustrating an exemplary delivery process according to a modified example; and

FIG. 13 is a hardware configuration diagram illustrating an exemplary computer that implements a function of an advertising device.

### DETAILED DESCRIPTION OF THE PREFERRED EMBODIMENTS

Hereinafter, modes (hereinafter, “embodiments”) for carrying out a delivery device, a delivery method, a delivery program, a facility device, and a delivery system according to the present disclosure will be described in detail with reference to the appended drawings. A delivery device, a delivery method, a delivery program, a facility device, and a delivery system according to the present disclosure are not limited to the following embodiments. In the following embodiments, the same parts are denoted by the same reference numerals, and a repeated description is omitted.

### 1. DELIVERY PROCESS

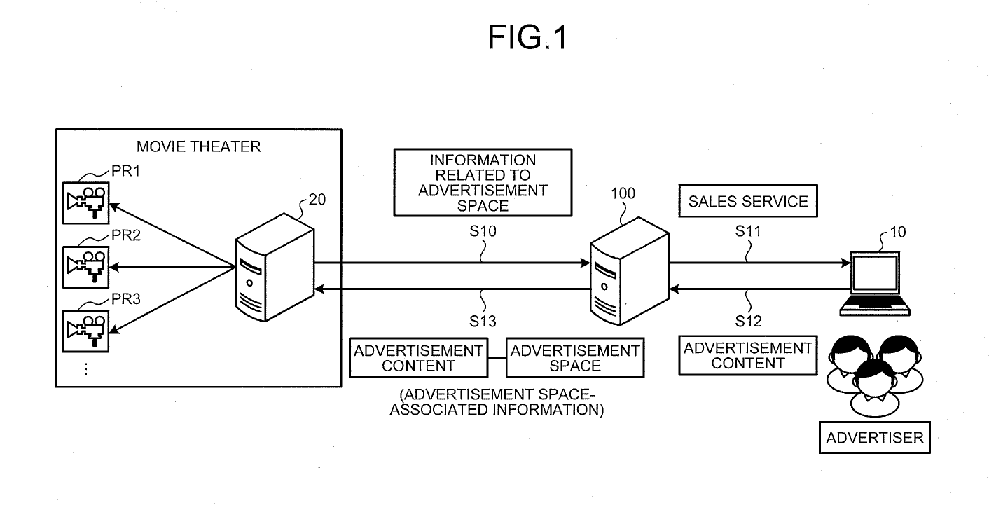

First, an exemplary delivery process according to an embodiment will be described with reference to FIG. 1. FIG. 1 is a diagram illustrating an exemplary delivery process according to an embodiment. FIG. 1 illustrates an example in which an advertising device 100 corresponding to a delivery device according to the present disclosure performs an advertisement delivery process. The following description will proceed in connection with an example in which a movie theater is described as a facility, a movie is described as first content provided in a facility, and advertisement content is described as second content provided together with the first content.

In the example illustrated in FIG. 1, a movie screened in a movie theater is provided with a space (which is also hereinafter referred to as an “advertisement space”) in which advertisement content is screened. For example, a few minutes of advertisement space is set before a main part of a movie. The advertising device 100 acquires information related to an advertisement space in which advertisement content is screened from a movie theater device 20 (step S10). The movie theater device 20 is an information processing device used by a movie theater administrator.

For example, the advertising device 100 is provided with information such as a name of a movie theater in which advertisement content is screened, a title of a movie in which an advertisement space is embedded, and a delivery schedule serving as a date and time at which advertisement content is screened in a movie theater as information related to an advertisement space. Further, the advertising device 100 stores a name of a movie theater, a title of a movie, a delivery schedule of advertisement content, and the like as information related to an advertisement space.

Then, the advertising device 100 sets a frame for which a bid is submitted from an advertiser terminal 10 operated by an advertiser based on the information related to the advertisement space provided from the movie theater device 20. In other words, the advertising device 100 organizes information such as a name of a movie theater to which an advertiser provides advertisement content, a title of a movie in which advertisement content is embedded, and a delivery schedule of advertisement content, and presents information related to a frame, for which a bid can be submitted, desired by an advertiser. For example, the advertising device 100 generates a user interface screen for displaying the information related to the advertisement space. Thus, the advertising device 100 can present the information related to the advertisement space for which a bid can be submitted to be easily understood by an advertiser.

Then, the advertising device 100 provides an advertisement space sales service to the advertiser terminal 10 operated by the advertiser while presenting the information related to the advertisement space as described above (step S11). Here, the advertisement space sales service indicates selling a right related to an advertisement space desired by an advertiser to an advertiser.

In the sales service, the information related to the advertisement space includes information related to a bidding price when an advertisement space is a bid target. Here, the bidding price indicates a sales price when an advertiser purchases a right related to an advertisement space. Further, the sales information presented by the advertising device 100 may include content of the information related to the advertisement space acquired from the movie theater device 20. In other words, in addition to the bidding price, the advertising device 100 may present a name of a movie theater in which advertisement content is screened, a title of a movie in which an advertisement space is embedded, a delivery schedule of advertisement content, and the like to the advertiser terminal 10 as the sales information. The advertising device 100 presents such information to the advertiser terminal 10 and then accepts a bid for an advertisement space.

Here, an advertiser selects a desired advertisement space based on the presented information. Then, the advertiser terminal 10 transmits a purchase request for a right related to a selected advertisement space to the advertising device 100 according to the advertiser's operation (step S12). For example, when a title of a movie in which advertisement content is desired to be embedded is already decided, the advertiser terminal 10 can designate a title of a movie in which an advertisement space is embedded and transmit a request to purchase an advertisement space. Then, upon receiving the purchase request for the right related to the advertisement space from the advertiser terminal 10, the advertising device 100 decides a purchaser of this right.

Then, the advertising device 100 accepts submission of advertisement content to be provided through the advertisement space from the advertiser terminal 10 corresponding to the advertiser who has acquired the right related to the advertisement space in the provided sales service. Then, the advertising device 100 stores the submitted advertisement content. Further, the advertising device 100 stores associated information (which is also hereinafter referred to as “advertisement space-associated information”) in which the advertisement space is associated with the submitted advertisement content.

Then, the advertising device 100 delivers the advertisement space-associated information to the movie theater device 20 together with the submitted advertisement content (step S13). Further, before delivering advertisement content to a movie theater, the advertising device 100 performs a conversion process necessary for causing advertisement content to adapt to screening equipment of a movie theater in which advertisement content is screened. The details of the conversion process will be described later.

Thereafter, the movie theater device 20 causes the submitted advertisement content to be screened on each screen based on the advertisement space-associated information. Specifically, the movie theater device 20 transmits the submitted advertisement content to the screening equipment equipped in each screen of the movie theater based on the information related to the advertisement space such as a title of a movie in which advertisement content is embedded and a delivery schedule. In the example of FIG. 1, the screening equipment equipped in each screen is a video projector, that is, a video projector PR1, a video projector PR2, and a video projector PR3. The video projectors PR1 to PR3 provide advertisement content to the audience by projecting the advertisement content onto different screens.

As described above, the advertising device 100 according to an embodiment provides the sales service related to an advertisement space of advertisement content provided together with a movie in a movie theater, and delivers the associated information in which advertisement content corresponding to an advertiser who has acquired a right related to an advertisement space in a provided sales service is associated with advertisement space information related to an advertisement space to a movie theater side.

Thus, using the advertising device 100 according to an embodiment, an advertiser can designate a desired condition and deliver advertisement content in a movie theater without performing a direct procedure with an individual movie theater side. For example, an advertiser can not only designate a title of a movie but also deliver advertisement content in each movie theater in which the movie of the title is screened. For example, an advertiser can not only designate a delivery schedule and but also deliver advertisement content in each movie theater in which a movie is screened according to the delivery schedule. Thus, an advertiser need not perform a complicated task of appropriately acquiring bidding information of a movie theater and submitting advertisement content to each screening place in connection with advertisement delivery in a movie theater. In other words, the advertising device 100 according to an embodiment can simplify an advertiser's task related to advertisement delivery and thus reduce an advertiser's burden.

The above embodiment has been described in connection with the example in which an advertisement is provided before a main part of a movie is screened. As described above, the second content provided together with the first content indicates, for example, an advertisement or a trailer for a movie provided before a main part when the movie main part is screened. The second content is assumed to include content that is provided to be overlaid with, that is, overlap the first content serving as the main part. In other words, the second content is not limited to content provided through an advertisement space embedded before the main part as in the above embodiment, and there are cases in which the second content is provided to overlap the first content serving as the main part. In this case, there are cases in which the information related to the advertisement space includes information indicating that the second content is provided to overlap the first content serving as the main part. Further, a right related to an advertisement space includes a right capable of embedding advertisement content in an advertisement space, a right capable of causing advertisement content to be overlaid with the first content serving as the main part, and the like. In other words, by acquiring the right, the advertiser can provide advertisement content through an advertisement space corresponding to the acquired right in a movie theater or causes advertisement content to be overlaid with the main part. Hereinafter, an expression of an “advertisement space” includes a concept of a right related to an advertisement space as well as an advertisement space.

### 2. CONFIGURATION OF DELIVERY SYSTEM

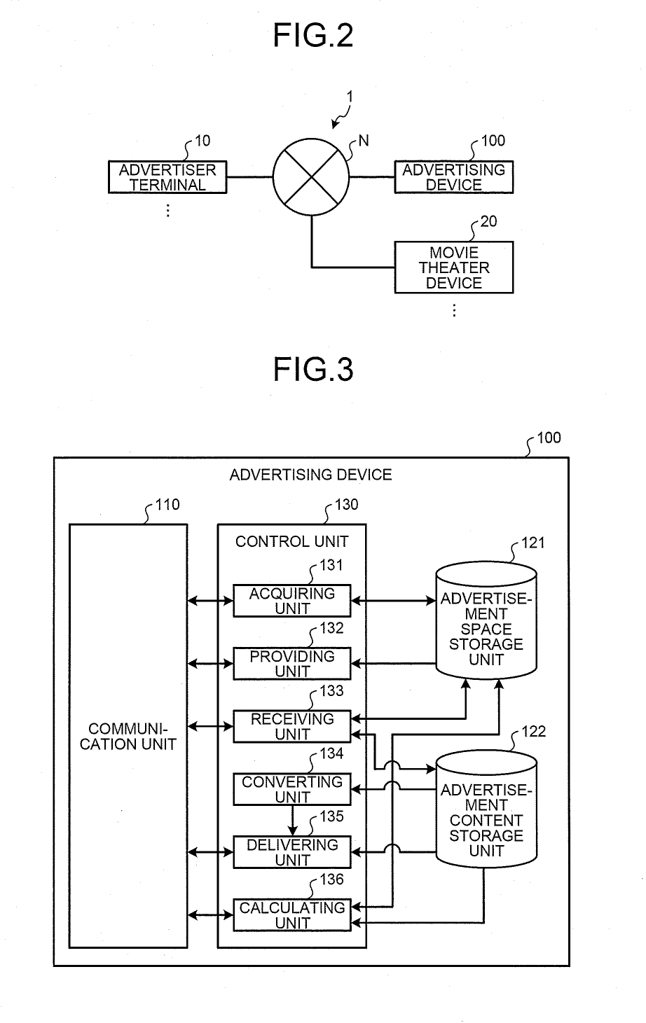

Next, a configuration of a delivery system according to an embodiment will be described with reference to FIG. 2. FIG. 2 is a diagram illustrating an exemplary configuration of a delivery system 1 according to an embodiment. The delivery system 1 includes the advertiser terminal 10, the movie theater device 20, and the advertising device 100 as illustrated in FIG. 2. The advertiser terminal 10, the movie theater device 20, and the advertising device 100 are connected to perform communication with one another via a network N in a wired or wireless manner. The delivery system 1 illustrated in FIG. 2 may include a plurality of advertiser terminals 10 or a plurality of movie theater devices 20.

The advertiser terminal 10 is an information processing device used by an advertiser who requests the advertising device 100 to deliver an advertisement delivery. For example, the advertiser terminal 10 is implemented by a desk top personal computer (PC), a lap top PC, a tablet terminal, a mobile telephone, a personal digital assistant (PDA), or the like.

Specifically, according to an operation performed by the advertiser, the advertiser terminal 10 transmits the purchase request for the right related to the advertisement space to the advertising device 100 or submits advertisement content to the advertising device 100.

The advertiser may request an agency to submit advertisement content without submitting advertisement content to the advertising device 100 using the advertiser terminal 10. In this case, an agency submits advertisement content to the advertising device 100. Hereinafter, an expression of “advertiser” is assumed to be a concept including an agency as well as an advertiser, and an expression of “advertiser terminal” is assumed to be a concept including an agency device used by an agency as well as an advertiser terminal.

The movie theater device 20 is a facility device used by a movie theater administrator. Specifically, for example, the movie theater device 20 manages the information related to the advertisement space, and performs a process of causing advertisement content delivered from the advertising device 100 to be screened in a movie theater.

The advertising device 100 is a server device that delivers advertisement content to the movie theater device 20. As described above with reference to FIG. 1, the advertising device 100 performs a process of acquiring information related to an advertisement space from the movie theater device 20 and providing a sales service for a right related to an advertisement space to the advertiser terminal 10.

### 3. CONFIGURATION OF ADVERTISING DEVICE

Next, a configuration of the advertising device 100 according to an embodiment will be described with reference to FIG. 3. FIG. 3 is a diagram illustrating an exemplary configuration of the advertising device 100 according to an embodiment. The advertising device 100 includes a communication unit 110, an advertisement space storage unit 121, an advertisement content storage unit 122, and a control unit 130 as illustrated in FIG. 3. The advertising device 100 may include an input unit (for example, a keyboard, a mouse, or the like) that receives various kinds of operations, for example, from an administrator using the advertising device 100 or a display unit (for example, a liquid crystal display (LCD) or the like) that displays various kinds of information.

### 3-1. Communication Unit

For example, the communication unit 110 is implemented by a network interface card (NIC) or the like. The communication unit 110 is connected with the network N in a wired or wireless manner, and transmits or receives information to or from the advertiser terminal 10 or the movie theater device 20 via the network N.

### 3-2. Storage Unit

For example, the advertisement space storage unit 121 and the advertisement content storage unit 122 are implemented by a semiconductor memory device such as a random access memory (RAM) or a flash memory or a storage device such as a hard disk or an optical disk.

### 3-3. Advertisement Space Storage Unit

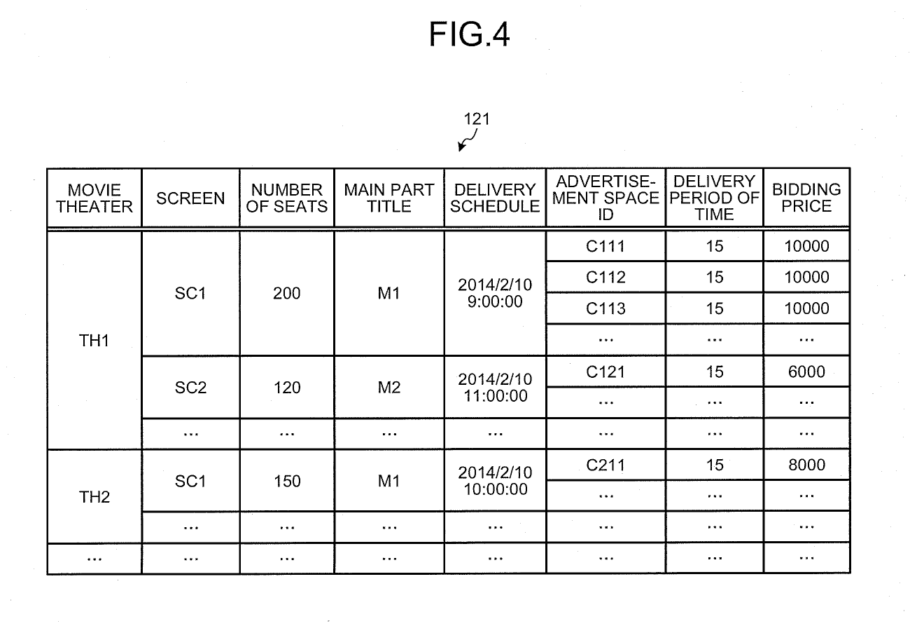

The advertisement space storage unit 121 stores information related to an advertisement space. FIG. 4 illustrates an example of the advertisement space storage unit 121 according to an embodiment. In the example illustrated in FIG. 4, the advertisement space storage unit 121 includes items such as a “movie theater,” a “screen,” the “number of seats,” a “main part title,” a “delivery schedule,” an “advertisement space ID,” a “delivery period of time,” and a “bidding price.” The advertising device 100 is assumed to acquire information related to an advertisement space from a plurality of movie theater managing devices as illustrated in FIG. 4.

The “movie theater” indicates a name of a movie theater to which advertisement content is delivered. For example, a movie theater “TH1” and a movie theater “TH2” indicate names of different movie theaters, and may differ in an ability to attract audience or an audience segment. For this reason, even when an advertisement space is embedded in the same movie, a bidding price may differ according to a movie theater. Although not illustrated, the “movie theater” may include facility information such as an address of a movie theater as well as a name of a movie theater.

The “screen” indicates a screening room equipped with a screen onto which a movie is projected and an auditorium in a movie theater. In FIG. 4, a screen “SC1” and a screen “SC2” in the movie theater “TH1” indicate different screening rooms and may differ in a movie to be screened or the number of seats.

The “number of seats” indicates the number of seats in the auditorium equipped in a screening place, and is a number indicating an audience capacity. The number of seats may differ according to a screen.

The “main part title” indicates a title of a movie (example of content) to be screened in a movie theater. For example, a main part title “M1” and a main part title “M2” indicate different main part content, and may differ in an ability to attract audience or an audience segment. Thus, advertisement spaces in the same movie theater may differ in a bidding price if main part titles differ. Although not illustrated, information including an item of “main part title” may include content information related to a movie as well as a title of a movie. For example, content information includes information such as an audience segment (for example, a sex or an age group) of an expected main audience, a leading cast, the attendance in the same title in other countries, or a reputation (for example, an ascending number of a search query) in the Internet.

The “delivery schedule” indicates a date and time at which advertisement content is delivered in a movie theater. Here, delivery is a concept including what advertisement content is screened in a movie theater and so the audience views advertisement content as well as what advertisement content is delivered via a network. In the example illustrated in FIG. 4, using a delivery schedule as an advertisement delivery start time, an advertisement is delivered in a designated screen in an advertisement space order.

The “advertisement space ID” indicates identification information identifying an advertisement space serving as a frame in which advertisement content is provided. For example, the advertiser can request the advertising device 100 to purchase a right related to an advertisement space for an advertisement space identified by an advertisement space ID “C111.” In the following, there are cases in which identification information stored in the advertisement space ID illustrated in FIG. 4 is used as a reference number of an advertisement space. For example, in the following, there are cases in which an advertisement space identified by the advertisement space ID “C111” is described as an “advertisement space C111.”

The “delivery period of time” indicates a duration in which advertisement content is delivered in a movie theater. In the example of FIG. 4, a unit of a delivery period of time is a second. For example, “15 seconds” is allocated to the advertisement space C111 as the delivery period of time.

The “bidding price” indicates a price when an advertisement space is a bid target in an advertisement space sales service. In other words, the “bidding price” indicates a price that is charged to an advertiser when an advertiser acquires a right related to an advertisement space. In the example illustrated in FIG. 4, “10000 yen” is charged to an advertiser when an advertiser acquires a right related to the advertisement space C111.

In other words, in the example illustrated in FIG. 4, the advertisement space C111 is an advertisement space embedded in a movie that is the main part title “M1” to be screened in the movie theater “TH1.” At this time, advertisement content corresponding to the advertisement space C111 is screened in the screen “SC1” in the movie theater “TH1” whose number of seats is “200” during “15 seconds” from “09:00:00, Feb. 10, 2014.” In the example illustrated in FIG. 4, the bidding price corresponding to the advertisement space C111 is “10000 yen.”

### 3-4. Advertisement Content Storage Unit

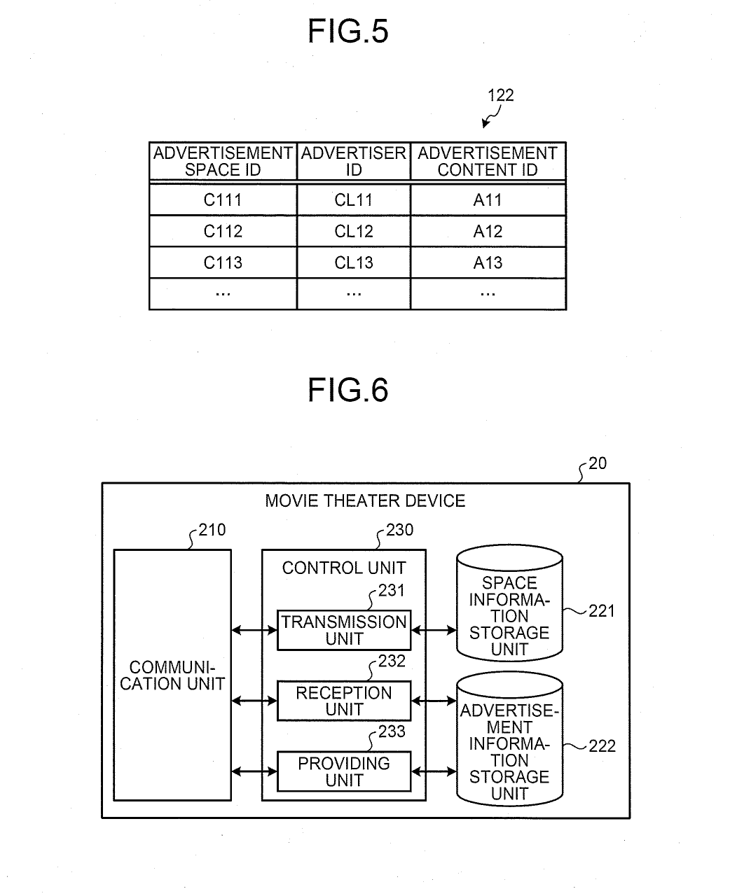

The advertisement content storage unit 122 stores information related to advertisement content submitted from the advertiser terminal 10. Specifically, the advertisement content storage unit 122 stores advertisement content corresponding to an advertiser who has acquired an advertisement space in a sales service provided through a providing unit 132 which will be described later and information related to an advertisement space as the advertisement space-associated information in association with each other. Here, FIG. 5 illustrates an example of the advertisement content storage unit 122 according to an embodiment. In the example illustrated in FIG. 5, the advertisement content storage unit 122 includes items such as an “advertisement space ID,” an “advertiser ID,” and “advertisement content ID.”

The “advertisement space ID” corresponds to the advertisement space ID illustrated in FIG. 4. The “advertiser ID” indicates identification information identifying an advertiser or the advertiser terminal 10.

The “advertisement content ID” indicates identification information identifying advertisement content submitted from an advertiser to the advertising device 100. Although not illustrated, the advertisement content storage unit 122 according to an embodiment stores advertisement content actually delivered in a movie theater. Specifically, the advertisement content storage unit 122 according to an embodiment stores data of advertisement content configured with, for example, a moving image to be screened in a movie theater.

In other words, in the example illustrated in FIG. 5, an advertiser identified by an advertiser ID “CL11” submits advertisement content identified by an advertisement content ID “A11” to an advertisement space “C111.”

Further, advertisement content to be actually delivered in a movie theater may be stored in an advertisement delivery server equipped separately from the advertising device 100. In this case, the advertising device 100 specifies advertisement content stored in an external advertisement delivery server based on an advertisement content ID stored in the advertisement content storage unit 122. Further, the advertising device 100 controls the advertisement delivery server such that the specified advertisement content is delivered to a movie theater.

### 3-5. Control Unit

For example, the control unit 130 is implemented such that a central processing unit (CPU), a micro processing unit (MPU), or the like executes various kinds of programs (corresponding to an example of a delivery program) stored in a storage device in the advertising device 100 through using a read only memory (RAM) as a work area. Further, for example, the control unit 130 is implemented by an integrated circuit such as an application specific integrated circuit (ASIC) or a field programmable gate array (FPGA).

As illustrated in FIG. 3, the control unit 130 includes an acquiring unit 131, the providing unit 132, a receiving unit 133, a converting unit 134, a delivering unit 135, and a calculating unit 136, and implements or executes an information processing function described below. An internal configuration of the control unit 130 is not limited to the configuration illustrated in FIG. 3, and the control unit 130 may have any other configuration capable of performing information processing which will be described later. Further, a connection relation of the respective processing units of the control unit 130 is not limited to the connection relation illustrated in FIG. 3, and may be any other connection relation.

### 3-6. Acquiring Unit

The acquiring unit 131 acquires information related to an advertisement space provided by the movie theater device 20, and stores the information in the advertisement space storage unit 121. Specifically, the acquiring unit 131 stores information such as the “movie theater,” the “screen,” the “number of seats,” the “main part title,” the “delivery schedule,” the “advertisement space ID,” and the “delivery period of time” in the advertisement space storage unit 121 as the information related to the advertisement space.

Further, besides information provided by the movie theater device 20, the acquiring unit 131 can acquire information related to another advertisement space and stores the information in the advertisement space storage unit 121. For example, the “bidding price” for the advertisement space may be set by the administrator of the advertising device 100. In this case, the acquiring unit 131 acquires the bidding price input by the administrator of the advertising device 100 as the information related to the advertisement space.

The acquiring unit 131 can update the information related to the advertisement space previously stored in the advertisement space storage unit 121. For example, when a title of a movie in which an advertisement space is embedded is replaced with another title, the movie theater device 20 changes the “main part title” item in the information related to the advertisement space. In this case, the acquiring unit 131 acquires new information from the movie theater device 20, and updates information stored in the advertisement space storage unit 121.

### 3-7. Providing Unit

The providing unit 132 provides a sales service related to an advertisement space of advertisement content provided together with a movie in a movie theater. In other words, the providing unit 132 sells a right capable of advertisement content in a movie theater together with a movie. Specifically, when the advertiser terminal 10 accesses the information related to the advertisement space, the providing unit 132 presents, for example, a bidding price to the advertiser terminal 10 as the information related to the advertisement space, and provides the advertiser terminal 10 with a sales service for a right related to an advertisement space.

The providing unit 132 can further present facility information related to a movie theater or content information related to a movie to be screen in a movie theater to the advertiser terminal 10 as the information related to the advertisement space. For example, the providing unit 132 presents a region in which a movie theater is located or information related to a time at which a movie is screened in a movie theater as the facility information. Further, the providing unit 132 presents, for example, information related to a title of a movie as the content information. For example, the facility information and the content information correspond to the “movie theater,” the “main part title,” the “delivery schedule,” and the “delivery period of time” of each “advertisement space ID” stored in the advertisement space storage unit 121. Further, information such as an audience segment of an expected main audience is included as the content information.

Further, the providing unit 132 can cause the advertiser terminal 10 to designate a provision condition (in other words, a condition on the movies for advertisers to provide advertisement content) and provide a sales service related to an advertisement space satisfying the designated provision condition. A concrete example in which the advertiser terminal 10 designates a title of a movie and acquires an advertisement space will be described below. Here, the advertiser is assumed to desire to provide advertisement content through an advertisement space embedded in a movie of the main part title “M1.” In this case, the advertiser terminal 10 designates the main part title “M1” as the advertisement space provision condition to the providing unit 132. Further, the providing unit 132 extracts an advertisement space satisfying the main part title “M1” serving as the designated provision condition. Referring to the example illustrated in FIG. 4, the providing unit 132 extracts, for example, advertisement spaces “C111,” “C112,” “C113” . . . , “C211” . . . embedded in the main part title “M1.” Further, the providing unit 132 presents the information related to the extracted advertisement spaces to the advertiser terminal 10, and accepts a purchase request to purchase the advertisement spaces.

As described above with reference to FIG. 4, the main part title includes the content information related to a movie as well as a title of a movie. In other words, the providing unit 132 can extract an advertisement space as content information related to a movie is designated by the advertiser terminal 10.

Next, a concrete example in which the advertiser terminal 10 designates a condition related to a movie theater, and acquires an advertisement space will be described. Here, the advertiser is assumed to desire to provide advertisement content in the movie theater “TH1.” In this case, the advertiser terminal 10 designates the movie theater “TH1” to the providing unit 132 as the advertisement space provision condition. Then, the providing unit 132 extracts an advertisement space satisfying the movie theater “TH1” serving as the designated provision condition. Referring to the example illustrated in FIG. 4, the providing unit 132 extracts the advertisement spaces “C111,” “C112,” “C113” . . . , “C121” . . . satisfying the movie theater “TH1.” Then, the providing unit 132 presents the information related to the extracted advertisement space to the advertiser terminal 10, and accepts a purchase request to purchase the advertisement spaces.

Further, the advertiser is assumed to desire to provide advertisement content at 9:00 am on an arbitrary date. In this case, the advertiser terminal 10 designates a delivery schedule “9:00:00” to the providing unit 132 as the advertisement space provision condition. Then, the providing unit 132 extracts an advertisement space satisfying the delivery schedule “9:00:00” serving as the designated provision condition. Referring to the example illustrated in FIG. 4, the providing unit 132 extracts the advertisement spaces “C111,” “C112,” “C113” . . . satisfying the delivery schedule “9:00:00.” Then, the providing unit 132 presents the information related to the extracted advertisement space to the advertiser terminal 10, and accepts a purchase request to purchase the advertisement spaces.

Further, the advertiser is assumed to desire to provide advertisement content in a screen in which the number of seats is 150 or more. In this case, the advertiser terminal 10 designates the number of seats of “150 or more” to the providing unit 132 as the advertisement space provision condition. Then, the providing unit 132 extracts an advertisement space satisfying the number of seats of “150 or more” serving as the designated provision condition. Referring to the example illustrated in FIG. 4, the providing unit 132 extracts the advertisement spaces “C111,” “C112,” “C113” . . . , “C211” . . . satisfying the number of seats of “150 or more.” Then, the providing unit 132 presents the information related to the extracted advertisement space to the advertiser terminal 10, and accepts a purchase request to purchase the advertisement spaces.

Practically, the providing unit 132 is considered to accept a combination of designations of the main part title, the delivery schedule (for example, when advertisement content is provided only during a certain week), and a movie theater (for example, when advertisement content is provided to a certain region) listed above as the provision condition. In this case, the providing unit 132 extracts an advertisement space according to each provision condition, and presents the information related to the extracted advertisement spaces to the advertiser terminal 10.

As described above, the providing unit 132 provides the sales service according to the advertiser's desire by causing the advertiser terminal 10 to designate the provision condition and extracting an advertisement space satisfying the designated provision condition.

Further, the providing unit 132 may not only provide the sales service before a movie is screened in a movie theater for the first time but also provide the sales service even after a movie is screened in a movie theater for the first time. Specifically, the advertiser does not necessarily purchase all advertisement spaces embedded in a movie before a movie is screened in a movie theater for the first time. Since a few weeks of a screening period of time are commonly set to a movie, an advertisement space may be sold as necessary even after a movie is screened in a movie theater for the first time. In this case, the providing unit 132 can present the content information such as an actual attendance or a main audience segment of a movie related to an advertisement space as the information related to the advertisement space.

### 3-8. Receiving Unit

The receiving unit 133 receives a purchase request for a right related to an advertisement space or submission of advertisement content from the advertiser terminal 10. Specifically, the receiving unit 133 receives a purchase request for a right related to an advertisement space from the advertiser terminal 10 using the sales service provided through the providing unit 132. At this time, the receiving unit 133 transmits information indicating that a right related to an advertisement space has been acquired to the advertiser terminal 10 from which the purchase request has been received. Then, the receiving unit 133 stores an advertiser ID corresponding to the advertiser terminal 10 that has acquired the right and an advertisement space ID in the advertisement content storage unit 122 in association with each other.

Further, the receiving unit 133 receives submission content from the advertiser terminal 10 that has acquired the right. Then, the receiving unit 133 stores the advertisement space ID related to the acquired advertisement space and an advertisement content ID identifying the submitted advertisement content in the advertisement content storage unit 122 as the advertisement space-associated information in association with each other.

### 3-9. Converting Unit

The converting unit 134 performs a conversion process on the submitted advertisement content. Specifically, the converting unit 134 detects whether or not advertisement content is appropriate to screening equipment of a movie theater in which advertisement content is screened before advertisement content is delivered to a movie theater together with the advertisement space-associated information, and converts the advertisement content into an appropriate format when the advertisement content is inappropriate to the screening equipment.

For example, the converting unit 134 converts a moving image that is a submitted advertisement content into a digital cinema package (DCP) that is a data format for digital cinema screening. Then, the converting unit 134 provides advertisement content converted into an appropriate format to the delivering unit 135 which will be described later.

Generally, the advertiser is required to submit advertisement content in a format corresponding to a facility of a submission destination when submitting advertisement content. Meanwhile, since the converting unit 134 according to an embodiment performs the conversion process on submitted advertisement content according to a movie theater of a delivery destination, and thus when the advertiser submits advertisement content in a certain format receivable by the receiving unit 133, it is unnecessary to prepare advertisement content having a format according to a delivery destination.

### 3-10. Delivering Unit

The delivering unit 135 delivers the advertisement space-associated information in which advertisement content corresponding to an advertiser who has acquired a right related to an advertisement space is associated with the information related to the advertisement space to the movie theater device 20 in the sales service provided by the providing unit 132.

Here, when the providing unit 132 provides a sales service related to an advertisement space satisfying a designated provision condition as the provision condition is designated from the advertiser, the delivering unit 135 delivers the advertisement space-associated information in which advertisement content corresponding to an advertiser who has acquired a right related to an advertisement space satisfying the provision condition is associated with the information related to the advertisement space to the movie theater device 20.

Further, the delivering unit 135 according to an embodiment delivers advertisement content to be actually delivered in a movie theater to a movie theater together with the advertisement space-associated information. Specifically, the delivering unit 135 delivers advertisement content such as a moving image stored in the advertisement content storage unit 122 in association with an advertisement space to the movie theater device 20 through the communication unit 110 a certain time (for example, 48 hours) before advertisement content is delivered in a movie theater.

Further, when there is advertisement content converted into an appropriate format through the converting unit 134, the delivering unit 135 delivers the converted advertisement content to the movie theater device 20.

### 3-11. Calculating Unit

The calculating unit 136 calculates a fee charged to an advertiser who has bided for an advertisement space in a sales service provided by the providing unit 132. Specifically, the calculating unit 136 according to an embodiment calculates a fee charged to an advertiser with reference to the advertisement space ID stored in the advertisement space storage unit 121, the bidding price of the advertisement space, and the advertiser ID stored in the advertisement content storage unit 122.

### 4. CONFIGURATION OF MOVIE THEATER DEVICE

Next, a configuration of the movie theater device 20 according to an embodiment will be described with reference to FIG. 6. FIG. 6 is a diagram illustrating an exemplary configuration of the movie theater device 20 according to an embodiment. The movie theater device 20 includes a communication unit 210, a space information storage unit 221, an advertisement information storage unit 222, and a control unit 230 as illustrated in FIG. 6. Further, the movie theater device 20 may include an input unit that receives various kinds of operations, for example, from the administrator using the movie theater device 20 or a display unit that displays various kinds of pieces of information.

For example, the communication unit 210 is implemented by an NIC or the like. The communication unit 210 is connected with the network N in a wired or wireless manner, and transmits or receives information to or from the advertising device 100 and the advertiser terminal 10 via the network N.

For example, the space information storage unit 221 and the advertisement information storage unit 222 are implemented by a semiconductor memory device such as a RAM or a flash memory or a storage device such as a hard disk or an optical disk.

The space information storage unit 221 stores the information related to the advertisement space. Here, the information related to the advertisement space stored by the space information storage unit 221 corresponds to the information stored in the advertisement space storage unit 121 illustrated in FIG. 4. In other words, the information related to the advertisement space stored by the space information storage unit 221 indicates information to be transmitted to the acquiring unit 131. For example, the space information storage unit 221 stores information related to an advertisement space such as the “movie theater,” the “screen,” the “number of seats,” the “main part title,” the “delivery schedule,” the “advertisement space ID,” and the “delivery period of time” which are illustrated in FIG. 4.

The advertisement information storage unit 222 stores information delivered from the delivering unit 135. In other words, the information stored in the advertisement information storage unit 222 corresponds to the information stored in the advertisement content storage unit 122 illustrated in FIG. 5. Specifically, the advertisement information storage unit 222 stores advertisement content submitted from the advertiser terminal 10 and the advertisement space-associated information of the advertisement content. For example, the advertisement information storage unit 222 stores information related to advertisement content such as the “advertisement space ID,” the “advertiser ID,” and the “advertisement content ID” which are illustrated in FIG. 5.

For example, the control unit 230 is implemented such that a CPU, an MPU, or the like executes various kinds of programs stored in a storage device in the movie theater device 20 using a RAM as a work area. Further, for example, the control unit 230 is implemented by an integrated circuit such as an ASIC or an FPGA.

A transmission unit 231 transmits information related to an advertisement space associated with advertisement content provided together with a movie to the advertising device 100 that provides a sales service related to an advertisement space. Specifically, the transmission unit 231 transmits the information related to the advertisement space stored in the frame information storage unit 221 to the advertising device 100.

A reception unit 232 receives the associated information in which advertisement content corresponding to an advertiser who has acquired a right related to an advertisement space is associated with advertisement space information related to an advertisement space from the advertising device 100 that has received the information related to the advertisement space. Specifically, the reception unit 232 receives information related to advertisement content that is stored in the advertisement content storage unit 122 and delivered from the delivering unit 135. Further, the reception unit 232 stores the received information related to advertisement content in the advertisement information storage unit 222.

A providing unit 233 provides advertisement content in a movie theater by transmitting advertisement content to screening equipment (for example, a video projector) equipped in a movie theater based on information related to advertisement content stored in the advertisement information storage unit 222. Specifically, the providing unit 233 detects a screening place and a screening date and time of advertisement content based on the advertisement space-associated information, and transmits the advertisement content to the screening equipment at an appropriate timing. Then, the providing unit 233 provides the advertisement content to the audience coming to the movie theater by causing the advertisement content to be projected onto a screen using the screening equipment.

### 5. DELIVERY PROCESS

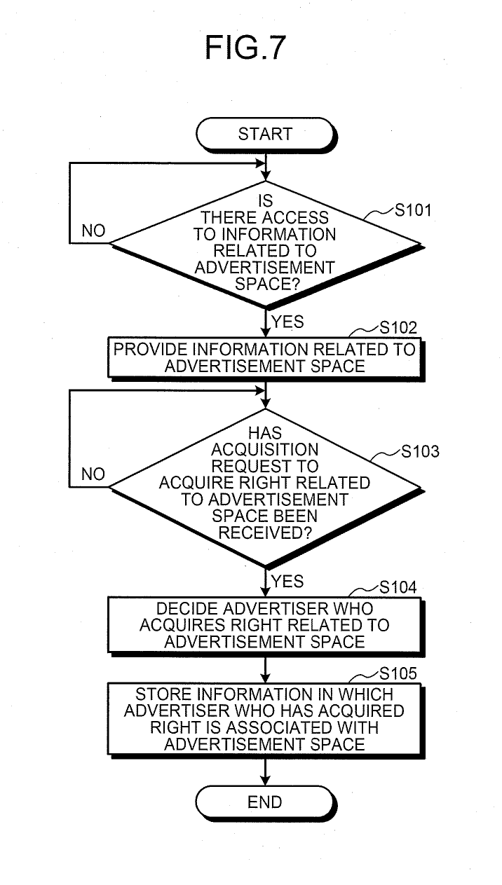

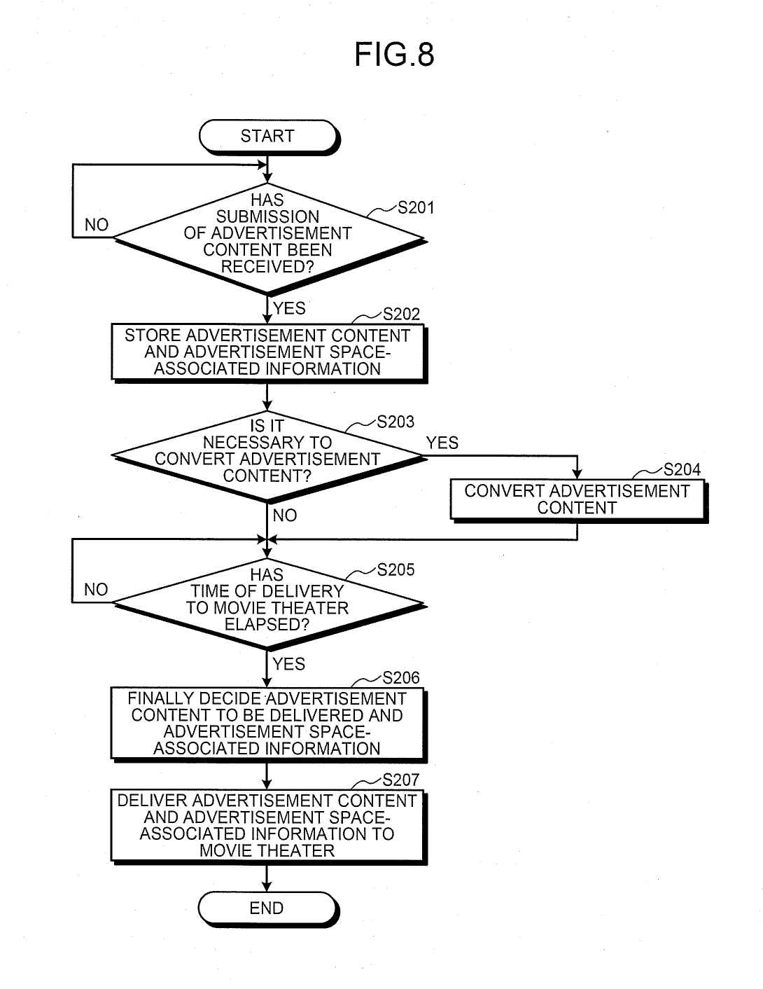

Next, the delivery process performed by the advertising device 100 according to an embodiment will be described with reference to FIGS. 7 and 8. FIGS. 7 and 8 are flowcharts illustrating the delivery process performed by the advertising device 100. In the following, the process of providing an advertisement space sales service through the advertising device 100 will be described with reference to FIG. 7, and the process of delivering correspondence information of an advertisement space and advertisement content through the advertising device 100 will be described with reference to FIG. 8.

First, the process of providing an advertisement space sales service through the advertising device 100 according to an embodiment will be described with reference to FIG. 7. FIG. 7 is a flowchart illustrating the process of providing an advertisement space sales service through the advertising device 100 according to an embodiment.

As illustrated in FIG. 7, the providing unit 132 determines whether or not there is access to the information related to the advertisement space from the advertiser terminal 10 (step S101). Then, when there is no access from the advertiser terminal 10 (No in step S101), the acquiring unit 131 is on standby until there is access from the advertiser terminal 10.

When there is access from the advertiser terminal 10 (Yes in step S101), the providing unit 132 presents the information related to the advertisement space to the advertiser terminal 10 (step S102).

Thereafter, the receiving unit 133 determines whether or not a request to acquire a right related to an advertisement space has been received from the advertiser terminal 10 (step S103). Then, when the request has not been received (No in step S103), the receiving unit 133 is on standby until the request is received.

However, when the request to acquire a right related to an advertisement space has been received by the receiving unit 133 (Yes in step S103), the receiving unit 133 decides the advertiser terminal 10 that acquires a right related to an advertisement space based on the request (step S104). Then, the receiving unit 133 associates and stores the advertisement space and information related to the advertiser terminal 10 in the advertisement content storage unit 122 in connection with the advertiser terminal 10 that has acquired the right related to the advertisement space (step S105). Thus, the process of providing a right related to an advertisement space to the advertiser terminal 10 through the advertising device 100 is completed.

Next, the process of delivering the advertisement space-associated information through the advertising device 100 according to an embodiment will be described with reference to FIG. 8. FIG. 8 is a flowchart illustrating the process of delivering the advertisement space-associated information through the advertising device 100 according to an embodiment.

As illustrated in FIG. 8, the receiving unit 133 determines whether or not submission of advertisement content delivered through an advertisement space has been received from the advertiser terminal 10 that has acquired a right related to an advertisement space (step S201). Then, when the submission has not been received (No in step S201), the receiving unit 133 is on standby until the submission is received.

Meanwhile, when the submission has been received by the receiving unit 133 (Yes in step S201), the receiving unit 133 stores the submitted advertisement content and the advertisement space-associated information in the advertisement content storage unit 122 (step S202).

Thereafter, the converting unit 134 detects whether or not advertisement content is appropriate to screening equipment of a movie theater serving as a delivery destination of advertisement content with reference to the advertisement space-associated information and the advertisement content. In other words, the converting unit 134 determines whether or not it is unnecessary to perform the conversion process on the advertisement content (step S203). Then, when the conversion process is unnecessary (No in step S203), the converting unit 134 does not perform the process of converting the advertisement content.

When the conversion process is determined to need to be performed through the converting unit 134 (Yes in step S203), the converting unit 134 performs the conversion process necessary to cause the advertisement content to adapt to the screening equipment of the movie theater (step S204).

Thereafter, the delivering unit 135 determines whether or not a time by which the advertisement space-associated information and the advertisement content are delivered to the movie theater has elapsed (step S205). Then, when the time by which the advertisement space-associated information and the advertisement content are delivered to the movie theater has not elapsed (No in step S205), the delivering unit 135 is on standby until time by which the advertisement space-associated information and the advertisement content are delivered to the movie theater elapses.

However, when the delivering unit 135 determines that the time by which the advertisement space-associated information and the advertisement content are delivered to the movie theater has elapsed (Yes in step S205), the delivering unit 135 finally decides the advertisement content to be delivered to the movie theater and the advertisement space-associated information (step S206).

Then, the delivering unit 135 delivers the advertisement content and the advertisement space-associated information to the movie theater device 20 (step S207). Thus, the process of delivering the advertisement space-associated information to the movie theater through the advertising device 100 is completed.

### 6. MODIFIED EXAMPLE

The advertising device 100 may be implemented in various kinds of different forms other than the above embodiment. In this regard, another embodiment of the advertising device 100 will be described below.

### 6-1. Advertisement Space Designation

The delivery process according to an embodiment has been described in connection with the example in which the advertising device 100 presents a title of a movie related to an advertisement space, a place of a movie theater, a delivery schedule, and the like to the advertiser terminal 10 as the information related to the advertisement space, receives the provision condition designated based on the information from the advertiser terminal 10, and provides the advertisement space sales service. However, the advertising device 100 may further present different information and provide the advertisement space sales service to the advertiser terminal 10.

An example of information related to the advertisement space sales service presented by the providing unit 132 will be described below. For example, the providing unit 132 presents information related to a movie theater, information related to the audience in a movie theater, and content information of a movie as the information related to the advertisement space sales service.

For example, the providing unit 132 may present information related to the number of seats to the advertiser terminal 10 as information related to a movie theater, cause a provision condition related to the number of seats to be designated, and provide an advertisement space sales service satisfying the provision condition. Here, the number of seats can be an index indicating how many people view advertisement content to be provided in a movie theater. Thus, advertisement content provided through an advertisement space in a screen having a large number of seats can be expected to provide a high advertising effect.

Further, the providing unit 132 can satisfy an advertiser's detailed desire by presenting information related to the number of seats. For example, the advertiser terminal 10 is considered to desire to designate the number of people viewing advertisement content and perform advertisement delivery. Specifically, when an advertiser desires to cause a certain number of people to view advertisement content on a certain date and time, the providing unit 132 can present information related to the number of seats and adjust the number of advertisement spaces to be acquired.

In addition, the providing unit 132 can present information a tendency or a genre (for example, a movie theater that usually screens movies for all ages, a movie theater that usually screens individualistic movies, or the like) of a movie provided in a movie theater, an operating company that operates a movie theater, the number of screens capable of simultaneously providing movies in a large-scaled movie theater, and a designated screen (for example, a screen with a special effect capable of screening a stereoscopic video or the like) in a movie theater as information related to a movie theater. The providing unit 132 can present the information to the advertiser terminal 10, cause the advertiser terminal 10 to designate a condition related to an advertisement space, and provide an advertisement space sales service.

Then, a concrete example of information related to the audience in a movie theater which is presented by the providing unit 132 will be described. For example, the providing unit 132 can calculate a predictive attendance and present this information to the advertiser terminal 10.

Here, various examples are considered as an index for obtaining the predictive attendance. For example, the providing unit 132 obtains the predictive attendance based on an attendance record value of the previous year in a movie theater, popularity or advance reviews of a movie to be embedded in an advertisement space, and the attendance for advanced screening in other countries, or the like. Further, the providing unit 132 can acquire the number of submissions related to content in a social networking service (SNS), the number of searches by a web search related to content, the number of introductions by the media such as newspapers, magazines, or televisions, or the like and obtain the predictive attendance using the number as an index via the network N. Further, the providing unit 132 may obtain the predictive attendance with reference to a relation between various kinds of pieces of information such as a category or a cast of a movie and a previous attendance record. Further, the providing unit 132 may change the predictive attendance after a movie is released. For example, the providing unit 132 may obtain the predictive attendance of advanced screening using the attendance directly after a movie is released or an increase rate in the attendance, or the like as an index. Further, the predictive attendance may be obtained based on the attendance record value of the previous year, popularity or advance reviews of a movie, or the like by the movie theater (for example, the movie theater device 20) instead of the advertising device 100. Further, the predictive attendance may be obtained by any other component configuring the control unit 130 instead of the providing unit 132.

Then, the providing unit 132 presents the predictive attendance obtained as the information related to the advertisement space to the advertiser terminal 10, and provides the advertisement space sales service. Thus, the advertiser terminal 10 can acquire an advertisement space based on the information related to the predictive attendance in the sales service provided by the providing unit 132.

In addition, the providing unit 132 can present information such as an actual attendance in a movie theater or an attribute of an audience as information related to an audience in addition to the predictive attendance. The providing unit 132 can present the information, cause the advertiser terminal 10 to designate a condition related to an advertisement space, and provide an advertisement space sales service.

The providing unit 132 can further present content information of a movie as the information related to the advertisement space sales service. For example, the providing unit 132 presents information related to a creator of a movie as the information related to the advertisement space sales service in addition to information related to content of a movie described in the above embodiment.

For example, the providing unit 132 presents information such as a creator of a movie, a director, a distribution company, the nationality of a creator, or a mobilization record of another movie by the same creator as information related to a creator of a movie.

Thus, the advertising device 100 can provide a sales service for an advertisement space expected to show a high advertising effect and thus can implement advertisement delivery leading to an advertising effect desired by an advertiser.

Further, the acquiring unit 131 acquires the information related to the advertisement space as information transmitted based on a screening schedule of a movie by the movie theater device 20. Specifically, the acquiring unit 131 acquires the information related to the advertisement space from the movie theater device 20 a certain time (for example, a week) before a movie is screened in a movie theater. However, a timing at which the acquiring unit 131 acquires the information related to the advertisement space is not limited to this example. For example, the acquiring unit 131 may acquire information related to an advertisement space transmitted based on availability of an advertisement space in a movie theater by the movie theater device 20. Specifically, the administrator of the movie theater device 20 is considered to sell an advertisement space independently, and a sales situation is considered to be not good (for example, an advertisement space is considered to be not sold). In this case, the movie theater device 20 may promote the sale of an advertisement space by transmitting the information related to the advertisement space to the acquiring unit 131.

Further, the providing unit 132 provides a sales service related to an advertisement space based on the information related to the advertisement space acquired by the acquiring unit 131, but an advertisement space to be sold is not limited to a frame that is set by the movie theater device 20 in advance. For example, the providing unit 132 can organize an advertisement space independently based on the information related to the advertisement space acquired by the acquiring unit 131 and provides a service of selling the advertisement space. As a concrete example, the acquiring unit 131 is assumed to have acquired an advertisement space having a duration of 15 minutes from the movie theater device 20. In this case, the providing unit 132 can divide an advertisement space having a duration of 15 minutes into 3 advertisement spaces having a duration of 5 minutes and sell the 3 advertisement spaces to the advertiser. Further, the providing unit 132 can receive a designation by the advertiser on an advertisement space that is acquired by the acquiring unit 131 and provide a service of selling the designated advertisement space as an advertisement space capable of providing advertisement content in a movie theater. In this case, the providing unit 132 can provide a service of selling an advertisement space to the advertiser in units of seconds. Thus, the advertiser can designate a duration and acquire an advertisement space capable of providing advertisement content in a movie theater.

Further, beside organizing an advertisement space and providing a sales service as described above, the providing unit 132 can provide a sales service in which a sales price varies according to a sales period of a right related to an advertisement space. For example, when the administrator of the movie theater device 20 sells an advertisement space independently but the sales situation is not good as described above, the acquiring unit 131 is assumed to have acquired the information related to the advertisement space. In this case, for this advertisement space, a period of time until advertisement content is provided is considered to be short. In this case, the providing unit 132 can lower the same price according to the sales period of time. In other words, the providing unit 132 can lower the sales price for an advertisement space in which a period of time until advertisement content is provided is short. Thus, the providing unit 132 can promote the sale of an advertisement space and improve a degree of satisfaction of the advertiser. Further, In this case, the providing unit 132 may provide an advertisement space to the advertiser for free.

### 6-2. Prohibited Matter

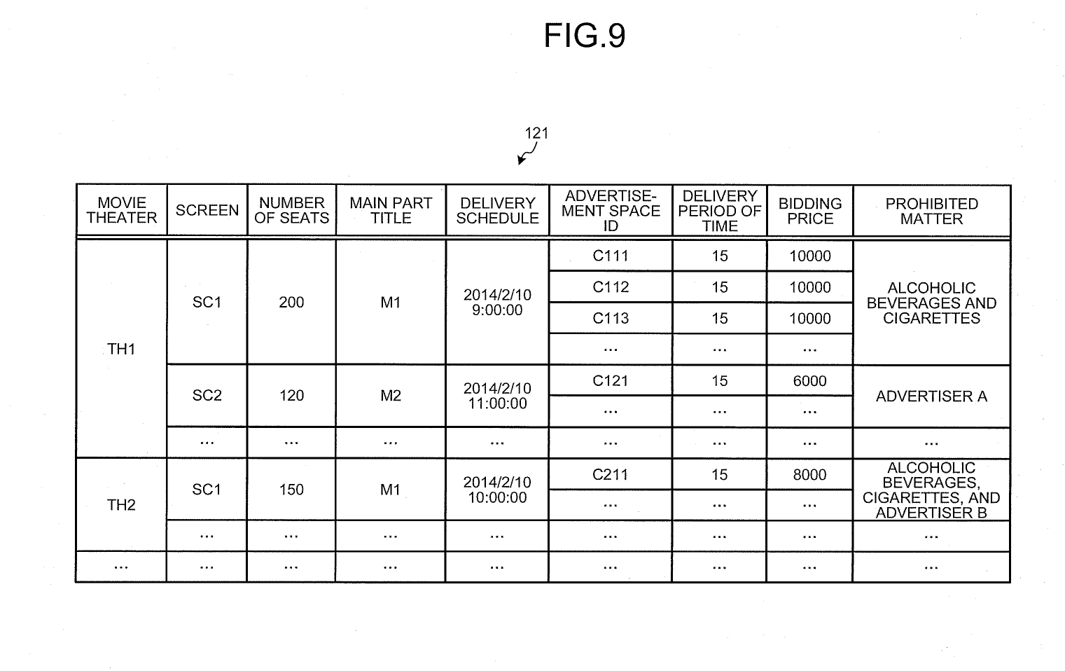

The delivery process according to an embodiment has been described in connection with the example in which the advertising device 100 presents a title of a movie related to an advertisement space, a place of a movie theater, a delivery schedule, and the like to the advertiser terminal 10 as the information related to the advertisement space, receives the provision condition designated from the advertiser terminal 10, and provides the advertisement space sales service. However, the advertising device 100 may further present different information and provide the advertisement space sales service to the advertiser terminal 10. For example, the advertising device 100 may set content of advertisement content that is not allowed to be delivered through an arbitrary advertisement space in advance and present this information to the advertiser terminal 10. This point will be described with reference to FIG. 9.

FIG. 9 is a diagram illustrating an example of an advertisement space storage unit 121 according to a modified example. A description of items corresponding to those of FIG. 4 is omitted. In the example illustrated in FIG. 9, the advertisement space storage unit 121 according to the modified example includes an item of a “prohibited matter.”

The “prohibited matter” indicates content of advertisement content that is not allowed to be delivered through an advertisement space or an advertiser that is not allowed to make a bid. In the example illustrated in FIG. 9, in an advertisement space “C111,” “alcoholic beverages” and “cigarettes” are set as a prohibited matter. For example, when a movie of a main part title “M1” includes content for children, it is difficult to provide content advertising alcoholic beverages or cigarettes as advertisement content. In this case, “alcoholic beverages” and “cigarettes” are set as a prohibited matter in advance.

In the example illustrated in FIG. 9, in an advertisement space “C121,” an “advertiser A” is set as a prohibited matter. For example, when a movie of a main part title “M2” is a work distributed by a business operator having a competitive relationship with the advertiser A, it is undesirable that advertisement content created by the advertiser A is provided through the advertisement space “C121.” In this case, the “advertiser A” is set as a prohibited matter in advance.

Further, in the example illustrated in FIG. 9, for an advertisement space “C211,” “alcoholic beverages,” “cigarettes” and an “advertiser B” are set as a prohibited matter. As described above, for the movie of the main part title “M1,” “alcoholic beverages” and “cigarettes” are set as a prohibited matter, and, for example, when a movie theater “TH2” is operated by a business operator having a competitive relationship with an advertiser B, it is undesirable that advertisement content by the advertiser B is provided through the advertisement space “C211.” In this case, “alcoholic beverages,” “cigarettes,” and “the advertiser B” are set as a prohibited matter in advance.

Further, the prohibited matter may be set by the administrator of the movie theater device 20 or may be set by the administrator of the advertising device 100. Specifically, when the administrator of the movie theater device 20 sets the prohibited matter in advance, the acquiring unit 131 acquires the information related to the advertisement space including the prohibited matter item from the movie theater device 20. Then, the providing unit 132 sets an advertisement space including the prohibited matter item based on the information related to the advertisement space including the prohibited matter item acquired from the movie theater device 20. Further, when the administrator of the advertising device 100 sets the prohibited matter, the administrator of the advertising device 100 inputs information related to the prohibited matter to the advertising device 100 using an input device equipped in the advertising device 100. Thus, the acquiring unit 131 acquires the input information related to the prohibited matter. Then, the providing unit 122 sets an advertisement space based on the input information related to the prohibited matter. Here, the prohibited matter may be decided by regulatory requirements or customary requirements.

Thus, the advertiser can extract and acquire an appropriate advertisement space according to content of advertisement content to be provided when acquiring an advertisement space. Accordingly, the advertising device 100 is unlikely to incur a mismatch in advertisement targeting.

### 6-3. Charging System 1

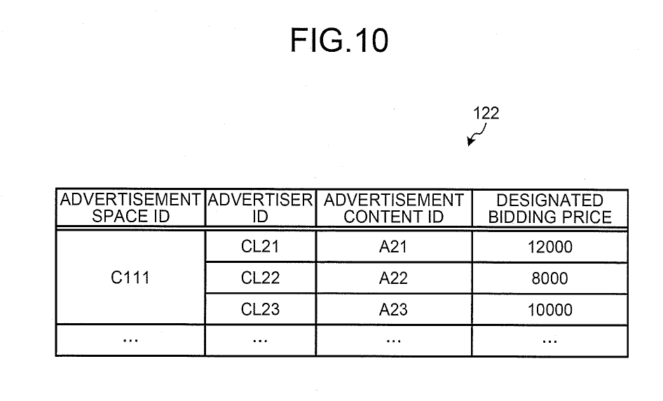

The delivery process according to an embodiment has been described in connection with the example in which the advertising device 100 presents the bidding price as the information related to the advertisement space, and accepts a bid for an advertisement space from the advertiser terminal 10. However, the advertising device 100 may accepts a bid for an advertisement space through a different technique. This point will be described with reference to FIG. 10.

FIG. 10 is a diagram illustrating an example of an advertisement content storage unit 122 according to a modified example. Further, a description of items corresponding to those of FIG. 5 is omitted. In the example illustrated in FIG. 10, the advertisement content storage unit 122 according to the modified example includes an item of a “designated bidding price.”

The “designated bidding price” indicates a bidding price designated by the advertiser terminal 10 at the time of a bid for an advertisement space. In this case, the advertiser terminal 10 is assumed not to be provided with a bidding price as the information related to the advertisement space in advance.

Here, the receiving unit 133 receives a bid for an advertisement space together with a bidding price designated by the advertiser terminal 10. Then, the receiving unit 133 stores the bidding price designated by the advertiser terminal 10 and the advertisement space serving as the bid target in the advertisement content storage unit 122 in association with each other.

In other words, in the example illustrated in FIG. 10, an advertiser “CL21” proposes a bidding price “12000 yen,” and makes a bid for an advertisement space “C111.” The advertiser CL21 submits advertisement content identified by an advertisement content ID “A21” after a bid. Similarly, an advertiser “CL22” proposes a bidding price “8000 yen,” makes a bid for an advertisement space “C111,” and submits advertisement content identified by an advertisement content ID “A22.” Similarly, an advertiser “CL23” proposes a bidding price “10000 yen,” makes a bid for an advertisement space “C111,” and submits advertisement content identified by an advertisement content ID “A23.”

In this case, after a certain time elapses, the receiving unit 133 decides an advertiser who acquires the advertisement space C111. Specifically, the receiving unit 133 decides the advertiser CL21 who has proposed the highest price in the bid as the advertiser who acquires the advertisement space C111. Then, the delivering unit 135 delivers the advertisement space-associated information in which the advertisement space “C111” is associated with the advertisement content identified by the advertisement content ID “A21” to the movie theater device 20. Thereafter, the calculating unit 136 charges the advertiser CL21 “12000 yen” that is the proposed bidding price.

Thus, the advertising device 100 can provide an advertisement space to the advertiser terminal 10 even when the bidding price is not set in advance. Further, there is an advantage that the advertiser can acquire a desired advertisement space with a high degree of accuracy by designating a bidding price higher than other advertisers.

### 6-4. Charging System 2

The advertising device 100 may accept a bid for an advertisement space through a different technique. For example, the advertising device 100 may accept a bid for an advertisement space through a pre-charging scheme of receiving an advertising fee related to provision of advertisement content from an advertiser as a budget and reducing the budget each time advertisement delivery is performed.

In this case, when the advertising fee of the advertisement content reaches the advertising budget, the advertising device 100 performs control such that the advertisement content is not delivered to the movie theater device 20. In this case, the advertising device 100 may inquire the advertiser of the advertisement content in which the advertising fee has reached the advertising budget about whether or not the advertising budget is increased. Further, when there is a remaining advertisement space as the advertising fee reaches the advertising budget, the advertising device 100 may provide the sales service to other advertisers.

### 6-5. Charging System 3

The advertising device 100 may accept a bid for an advertisement space through a different technique. For example, the advertising device 100 may charge an advertiser based on an actual attendance without setting bidding price for an advertisement space. Specifically, after providing advertisement content through an arbitrary advertisement space, the advertising device 100 is provided with information related to an actual attendance from a movie theater.

For example, a movie theater (for example, the movie theater device 20) can obtain the attendance based on information obtained from selling terminals that sell tickets. Here, the present invention is not limited to this example, and, for example, a movie theater is provided with an audience information acquiring device that acquires information of an audience that actually comes to a movie theater. For example, the audience information acquiring device corresponds to one or more devices such as a camera and an access points. For example, when a camera is included as the audience information acquiring device, the camera photographs the inside of a movie theater. Thus, the movie theater device 20 can obtain the attendance from the image photographed by the audience information acquiring device. Further, when the access point is included as the audience information acquiring device, the access point communicates with a mobile terminal held by each spectator through a wireless communication such as wireless fidelity (Wi-Fi). Thus, the movie theater device 20 can obtain the attendance by counting the number of mobile terminal that has communicated with the audience information acquiring device.

Then, the calculating unit 136 acquires information related to an actual attendance obtained by the above technique from the movie theater device 20, calculates a fee related to acquisition of an advertisement space based on the actual attendance and a previously set unit price per mobilized person, and charges the advertiser the fee.

### 6-6. Reputation

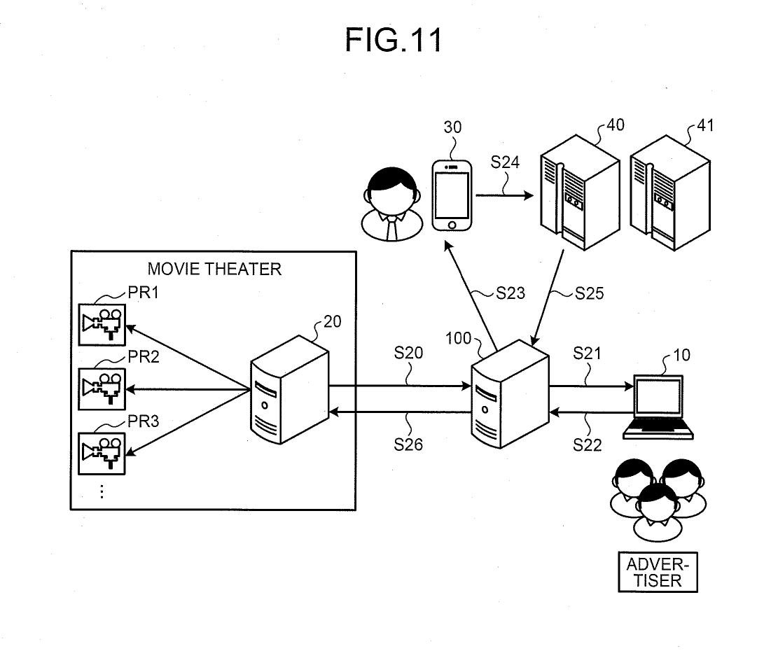

The delivery process according to an embodiment has been described in connection with the example in which the advertising device 100 is provided with the information related to the advertisement space from the movie theater device 20, and delivers advertisement content and the advertisement space-associated information to the movie theater device 20. However, the advertising device 100 may provide advertisement content to a place other than a movie theater and select advertisement content to be delivered to the movie theater device 20 based on a reputation thereof. This point will be described with reference to FIG. 11.

FIG. 11 is a diagram illustrating an exemplary delivery process according to a modified example. FIG. 11 illustrates an example in which the advertisement delivery process is performed by the advertising device 100 corresponding to a delivery device according to a modified example. Further, step S20, step S21, and step S22 illustrated in FIG. 11 correspond to step S10, step S11, and step S12 illustrated in FIG. 1, and thus a description thereof is omitted. Referring to FIG. 11, a user terminal 30 is, for example, a tablet terminal, a mobile telephone, a PDA, or the like, and used to browse a web page or request a web server to deliver an advertisement delivery. A search engine server 40 is a web server, and, for example, performs a service of receiving a search query from the user terminal 30 and transmitting a search result to the user terminal 30. Further, an SNS server 41 is a web server, and provides an SNS. Further, in the example illustrated in FIG. 11, an advertiser CL11 is assumed to submit an advertisement content A11 to the advertisement space C111. Here, the advertisement content A11 is advertisement content including a moving image corresponding to a web delivery.

In the example illustrated in FIG. 11, when the advertising device 100 is a web server, the advertising device 100 delivers advertisement content for a web page as well as advertisement content to be provided in a movie theater. In the example illustrated in FIG. 11, the advertising device 100 receives the delivery request for the advertisement content A11 from the user terminal 30. The advertising device 100 receives the delivery request, and delivers the advertisement content A11 corresponding to the web page to the user terminal 30 (step S33).

The user of the user terminal 30 that has received the delivered advertisement content A11 is considered to give some sort of reaction when the user has particular interest in the advertisement content A11. For example, the user terminal 30 uses the search service provided by the search engine server 40 using a product name advertised by the advertisement content A11 or a name of the advertiser CL11 serving as an business operator delivering the advertisement content A11 as a search query according to the user's operation. Further, the user terminal 30 posts articles related to the product name advertised by the advertisement content A11 or the name of the advertiser CL11 serving as an business operator delivering the advertisement content A11 to the SNS provided by the SNS server 41 (step S24).

Then, the advertising device 100 acquires information about a reputation of the advertisement content A11 from the search engine server 40 or the SNS server 41 (step S25). Specifically, the advertising device 100 accesses the search engine server 40, and acquires the number of search queries about the product name advertised by the advertisement content A11 or the name of the advertiser CL11 serving as an business operator delivering the advertisement content A11. Further, the advertising device 100 accesses the SNS server 41, and acquires the number of posted articles related to the advertisement content A11. For example, the advertising device 100 determines that the advertisement content A11 in which the number of search queries or the number of posted articles is large has a high reputation.

Thereafter, the advertising device 100 selects advertisement content to be delivered to the movie theater device 20 based on the reputation. For example, when the advertisement content A11 is determined to have a good reputation and a high advertising effect, the advertising device 100 delivers the advertisement content A11 and the advertisement space-associated information corresponding to the advertisement space C111 to the movie theater device 20 (step S26).

Generally, it is mostly difficult to determine an advertising effect of advertisement content until advertisement content is provided to the public and an evaluation is obtained. For example, even in the case of a video work having excellent advertisement content, it is difficult to know how much its advertising effect can appeal to the public as an advertisement.

Further, for example, advertisement content to be provided in a movie theater hardly receives a feedback such as a click operation performed by the user, unlike advertisement content to be delivered through a web page. For this reason, it is preferable that advertisement content to be actually provided in a movie theater be advertisement content capable of improving the visibility of an advertising target (for example, a company, a product, or the like) through the delivery. Advertisement content capable of improving the visibility is advertisement content capable of improving a branding effect by viewing and thus desirable as advertisement content in a movie theater that hardly receives a click operation or the like performed by the user.

In other words, the advertising device 100 according to the modified example can obtain an evaluation related to the visibility of advertisement content via a web network at a stage before advertisement content is delivered to a movie theater and select advertisement content desired to be provided in a movie theater.

Here, the advertising device 100 may receive submission of several pieces of advertisement content from the same advertiser in advance. For example, before advertisement content is provided in a movie theater, the advertising device 100 delivers several pieces of advertisement content to a web page, and sounds out a reputation of the advertisement content. Thus, the advertising device 100 can select advertisement content having the highest visibility from among several pieces of submitted advertisement content and deliver the selected advertisement content to the movie theater device 20.

Further, for example, the advertising device 100 delivers advertisement content scheduled to be provided in a movie theater to web page, and sounds out a reputation thereof. Then, the advertising device 100 may acquire an evaluation related to the visibility of the advertisement content and notify the advertiser of the evaluation. Thus, when the evaluation is not good, the advertising device 100 urges the advertiser to change the submitted advertisement content.

As described above, the advertising device 100 according to the modified example can select advertisement content expected to further improve the visibility of the advertising target and deliver the advertisement content to a movie theater side. Accordingly, the advertising device 100 according to the modified example can increase the advertising effect of the advertisement content to be delivered.

Further, in the modified example, content delivered to a web is not limited to the same content as advertisement content to be delivered to a movie theater. For example, content delivered to a web may be content provided by the same advertiser as content to be delivered to a movie theater or may be content obtained by organizing content to be delivered to a movie theater to have a short duration to be used in a web. In this case, content delivered to a web is not limited to content delivered by the delivering unit 135 as in the modified example, and may be content delivered from another arbitrary web server.

Further, in the modified example, the web page is not limited to a web page for use in desk top PCs and includes a web page to be delivered for use in a tablet terminal, a mobile telephone, a PDA, or the like as well. Furthermore, in the modified example, the web page is assumed to also include content displayed by service (for example, a moving image provision application using a network) provided by an application for use in a tablet terminal or the like.

### 6-7. Management Device

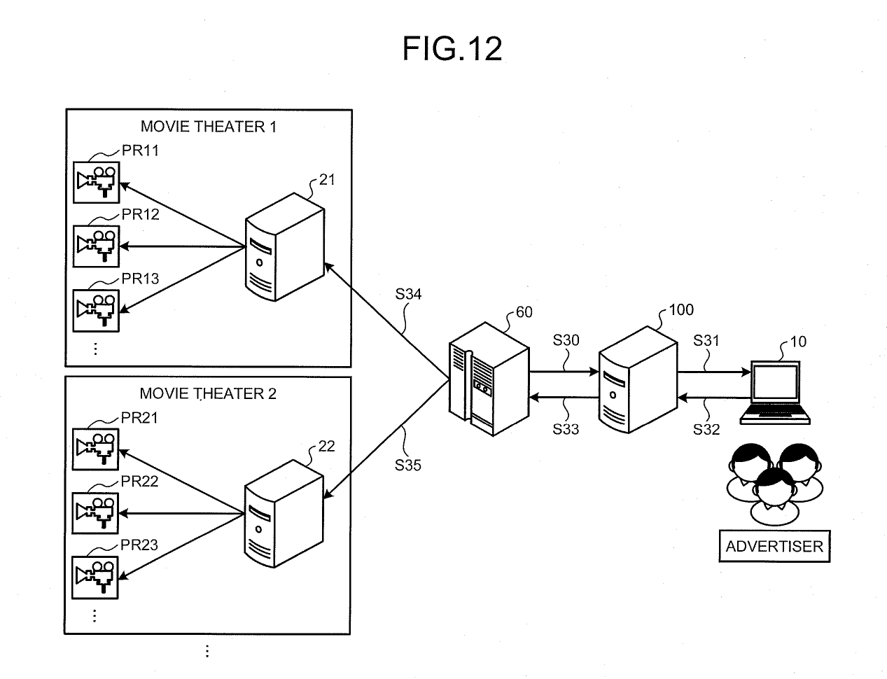

The delivery process according to an embodiment has been described in connection with the example in which the advertising device 100 is provided with the information related to the advertisement space from the movie theater device 20, and delivers advertisement content and the advertisement space-associated information to the movie theater device 20. However, the advertising device 100 can perform the same process on a central movie theater managing device 60 that manages, for example, a plurality of movie theater devices 20 instead of the movie theater device 20. This point will be described with reference to FIG. 12. The following description will proceed in connection with an example in which a movie theater device 21 and a movie theater device 22 are a plurality of movie theater devices 20.

FIG. 12 is a diagram illustrating an exemplary delivery process according to a modified example. FIG. 12 illustrates an example in which the advertisement delivery process is performed by the advertising device 100 corresponding to a delivery device according to a modified example. In FIG. 12, the movie theater managing device 60 is a server device that concentrically manages a plurality of movie theater devices 20, and stores, for example, information related to an advertisement space related to the managed movie theater device 21 and the managed movie theater device 22. Although not illustrated, the movie theater managing device 60 may manage more movie theater devices 20.

In the example illustrated in FIG. 12, the advertising device 100 is provided with the information related to the advertisement space from the movie theater managing device 60, and acquires the information (step S30). Further, step S31 and step S32 illustrated in FIG. 12 correspond to step S11 and step S12 illustrated in FIG. 1, and thus a description thereof is omitted.

Then, the advertising device 100 delivers the advertisement space-associated information to the movie theater managing device 60 together with the submitted advertisement content (step S33). The movie theater managing device 60 delivers the advertisement content to the movie theater device 21 equipped in a movie theater 1 based on the advertisement space-associated information acquired from the advertising device 100 (step S34). Similarly, the movie theater managing device 60 delivers the advertisement content to the movie theater device 22 equipped in a movie theater 2 (step S35). The movie theater device 21 transmits the delivered advertisement content to the video projectors PR11 to PR13, and causes the video projectors PR11 to PR13 to screen the advertisement content. Similarly, the movie theater device 22 transmits the delivered advertisement content to the video projectors PR21 to PR23, and causes the video projectors PR21 to PR23 to screen the advertisement content.

As described above, the advertising device 100 can performs a series of delivery processes on the movie theater managing device 60 and provide the advertisement content in the movie theater, similarly to the delivery process according to an embodiment.

In this case, compared to the delivery process according to the embodiment, the delivery process performed by the advertising device 100 can be simplified. Specifically, in the delivery process according to an embodiment, in order to acquire the information related to the advertisement space in a plurality of movie theaters, the advertising device 100 needs to acquire information from a plurality of movie theater devices 20. Further, the advertising devices 100 need to delivers the advertisement space-associated information to the corresponding movie theater devices 20.

Meanwhile, in the delivery process according to the modified example, the advertising device 100 performs processing with the movie theater managing device 60, and obtains the same result as the result obtained by performing processing on a plurality of movie theater devices 20. In other words, compared to the delivery process according to an embodiment, the advertising device 100 can simplify a series of delivery processes.

For example, the movie theater managing device 60 is managed by a movie theater side (for example, a distribution company) serving as a facility. An expression of “facility” or “movie theater” is assumed to be a concept including the movie theater managing device 60.

### 6-8. Position of Advertisement Space

The above embodiments have been described in connection with the example in which an advertisement space is embedded in a main part of a movie. In other words, the above embodiments have been described in connection with the example in which advertisement content is screened before a main part of a movie. However, a timing at which advertisement content is screened is not limited to this example. In other words, advertisement content may be provided together with a movie such that advertisement content is screened in the middle of a main part of a movie or such that advertisement content is screened after a main part of a movie.

### 6-9. Exemplary Content

Further, the above embodiments have been described in connection with the example in which the first content provided in a facility is a movie, and the second content provided together with the first content is an advertisement. However, the present invention is not limited to this example, and each content may have various forms. For example, various kinds of events held involving an audience such plays or concerts may be included as the first content. Further, for example, a short film created by an individual creator may be included as the second content. In this case, an individual creator who has created a short film is a provider of the second content. Thus, the advertising device 100 can meet the need of an individual creator who desires to screen a short film work created by himself/herself in a space such as a movie theater.

### 6-10. Replacement of Advertisement Space

Further, in the above embodiments, the advertising device 100 may receive submission of advertisement content from the advertiser a number of times. In this case, the advertising device 100 delivers the latest advertisement content submitted from the advertiser to the movie theater device 20. Thus, the advertiser who has purchased the right capable of embedding advertisement content in a movie can replace advertisement content.

6-11. Others

Among the processes described in the above embodiments, all or some processes described to be performed automatically may be performed manually, or all or some processes described to be performed manually may be performed automatically by a known method. Further, a processing process, a concrete name, or information including various kinds of data or parameters described in this document or the drawings can be arbitrarily changed unless specifically mentioned above. For example, various kinds of information illustrated in the drawings are not limited to illustrated information.

Further, the respective components of the respective devices illustrated in the drawings are functionally conceptual ones, and need not necessarily be physically configured as illustrated in the drawings. In other words, a concrete form of distribution or integration of the respective devices is not limited to the illustrated one, and some or all thereof may be configured to be distributed or integrated in arbitrarily units functionally or physically according to various kinds of loads or use statuses.

For example, the above embodiments have been described in connection with the example in which the delivery system 1 includes the advertiser terminal 10, the movie theater device 20, and the advertising device 100 as illustrated in FIG. 2, but the delivery system 1 is considered to be configured in another form. For example, the delivery system 1 may include an advertisement bidding management server that controls a plurality of advertiser terminals 10 in general. In this case, the advertising device 100 provides the information related to the advertisement space and the advertisement space sales service to the advertisement bidding management server.

Further, for example, the advertising device 100 illustrated in FIG. 3 may be distributed into a providing device that acquires the information related to the advertisement space and provides the sales service and a delivery device that delivers advertisement content. In this case, the providing device may not include the delivering unit 135 illustrated in FIG. 3. Further, the delivery device may not include the acquiring unit 131, the providing unit 132, and the receiving unit 133 illustrated in FIG. 3.

Further, for example, the advertisement space storage unit 121 or the advertisement content storage unit 122 illustrated in FIG. 3 may be held in a storage server (not illustrated) or the like other than the advertising device 100. In this case, the advertising device 100 acquires various kinds of pieces of information stored in the advertisement space storage unit 121 or the advertisement content storage unit 122.

Further, for example, a movie theater includes a device that acquires information indicating that an advertisement has been screened in a movie theater. Specifically, a movie theater includes a sound collecting device that collects a sound actually output from an advertisement in a movie theater. For example, the advertising device 100 can receive collected sound data from the movie theater device 20 and present the collected sound data to the advertiser as information. Thus, the advertising device 100 can meet a need of an advertiser who desires to check that advertisement has been actually screened in a movie theater through an acquired advertisement space.

Further, the above embodiments can be appropriately combined as long as processing content is not contradictory.

### 6-12. Hardware Configuration

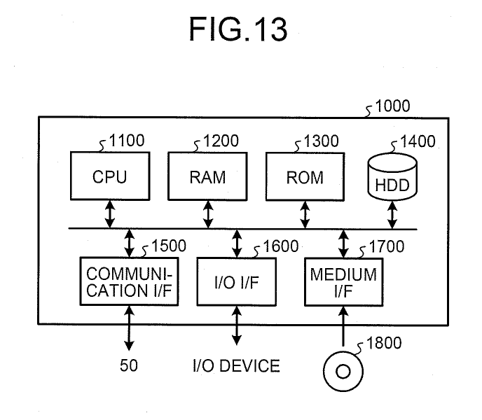

The advertising device 100 according to the embodiment is implemented, for example, by a computer 1000 having a configuration illustrated in FIG. 13. The following description will proceed in connection with an, example of the advertising device 100. FIG. 13 is a hardware configuration diagram illustrating an example of the computer 1000 that implements the function of the advertising device 100. The computer 1000 includes a CPU 1100, a RAM 1200, a ROM 1300, a HDD 1400, a communication interface (I/F) 1500, an input/output (I/O) I/F 1600, and a medium I/F 1700.

The CPU 1100 operates based on a program stored in the ROM 1300 or the HDD 1400, and controls the respective components. The ROM 1300 stores a boot program executed by the CPU 1100 when the computer 1000 is activated, a program depending on hardware of the computer 1000, and the like.

The HDD 1400 stores a program executed by the CPU 1100, data used by the program, and the like. The communication I/F 1500 receives data from another device via a communication network 50 (corresponding to the network N illustrated in FIG. 2), transfers the received data to the CPU 1100, and transmits data generated by the CPU 1100 to another device via the communication network 50.

The CPU 1100 controls an output device such as a display or a printer and an input device such as a keyboard or a mouse through the I/O I/F 1600. The CPU 1100 acquires data from the input device through the I/O I/F 1600. Further, the CPU 1100 outputs generated data to the output device through the I/O I/F 1600.

The medium I/F 1700 reads out a program or data stored in a recording medium 1800, and provides the read program or data to the CPU 1100 through the RAM 1200. The CPU 1100 loads the program from the recording medium 1800 onto the RAM 1200 through the medium I/F 1700, and executes the loaded program. Examples of the recording medium 1800 include an optical recording medium such as a digital versatile disc (DVD) or a phase change rewritable disk (PD), a magneto optical recording medium such as a magneto-optical disk (MO), a tape medium, a magnetic recording medium, and a semiconductor memory.

For example, when the computer 1000 functions as the advertising device 100 according to an embodiment, the CPU 1100 of the computer 1000 executes the program loaded onto the RAM 1200 and implements the function of the control unit 130. Further, the HDD 1400 stores data in the advertisement space storage unit 121 and the advertisement content storage unit 122. The CPU 1100 of the computer 1000 reads the program from the recording medium 1800 and executes the program, but the program may be acquired from another device through the communication network 50.

### 7. EFFECTS

As described above, the advertising device 100 according to an embodiment includes the providing unit 132 that provides a sales service of an advertisement space related to advertisement content (an example of second content) provided together with a movie (an example of first content) in a movie theater and the delivering unit 135 that delivers associated information in which advertisement content corresponding to an advertiser who has acquired a right related to an advertisement space in the sales service provided by the providing unit 132 is associated with information related to an advertisement space to the movie theater side.

Thus, the advertising device 100 according to an embodiment can reduce an advertiser's burden in advertisement delivery.

Further, the providing unit 132 according to an embodiment causes a provision condition for providing advertisement content to be designated, and provides a sales service related to an advertisement space satisfying a designated provision condition. Further, the delivering unit 135 according to an embodiment delivers associated information in which advertisement content corresponding to an advertiser who has acquired a right related to an advertisement space is associated with information related to an advertisement space satisfying a provision condition designated by the advertiser.

Thus, the advertising device 100 according to an embodiment can implement advertisement delivery according to an advertiser's desire.

Further, the providing unit 132 according to an embodiment causes an advertiser to designate a condition related to a movie theater as a provision condition, and provides a sales service.

Thus, the advertising device 100 according to an embodiment can implement advertisement delivery according to an advertiser's desire in connection with a facility providing advertisement content.

In addition, the providing unit 132 according to an embodiment causes an advertiser to designate at least one of a region in which a movie theater is located, a schedule in which a movie is provided in a movie theater, and the number of seats of a movie theater as a condition related to a movie theater, and provides a sales service.

Thus, the advertising device 100 according to an embodiment can implement advertisement delivery satisfying an advertiser's detailed desire in connection with a facility providing advertisement content.

Further, the providing unit 132 according to an embodiment causes an advertiser to designate a condition related to a movie in which an advertisement space is embedded as a provision condition, and provides a sales service.

Thus, the advertising device 100 according to an embodiment can implement advertisement delivery according to an advertiser's desire in connection with a movie provided together with advertisement content.

Further, the providing unit 132 according to an embodiment causes a title or content of a movie to be designated as a condition related to a movie, and provides a sales service.

Thus, the advertising device 100 according to an embodiment can implement advertisement delivery satisfying an advertiser's detailed desire in connection with a movie provided together with advertisement content.

Further, the delivering unit 135 according to an embodiment delivery advertisement content corresponding to an advertiser who has acquired a right related to an advertisement space to a terminal device that displays a web page, and selects advertisement content to be delivered to a movie theater side based on a reputation on delivered advertisement content.

Thus, the advertising device 100 according to an embodiment can select advertisement content expected to improve the visibility of the advertising target and deliver the selected advertisement content to a movie theater side. Accordingly, the advertising device 100 according to an embodiment can increase an advertising effect of advertisement content to be delivered.

Further, the providing unit 132 according to an embodiment presents a predictive value of the attendance of a movie theater, and provides a sales service.

Thus, the advertising device 100 according to an embodiment can implement advertisement delivery leading to an advertising effect desired by an advertiser.

Further, the advertising device 100 according to an embodiment further includes the converting unit 134 that converts advertisement content corresponding to an advertiser who has acquired an advertisement space into a format providable in a movie theater. Furthermore, the delivering unit 135 according to an embodiment delivers associated information in which advertisement content converted by the converting unit 134 is associated with information related to an advertisement space to a movie theater.

Thus, the advertising device 100 according to an embodiment can cause an advertiser to submit advertisement content regardless of format of advertisement content and thus reduce an advertiser's burden on advertisement delivery.

The embodiment of the present disclosure have been described above in detail with reference to the appended drawings, but the above embodiments are examples, and the present invention can be implemented in different forms in which various modifications or improvements are made from the aspects described in the disclosure of the invention based on knowledge of a person skilled in the art.

Further, “section, module, or unit” described above can be interpreted as “means,” “circuit,” or the like. For example, the providing unit can be interpreted as a providing means or a providing circuit.

According to an aspect of the embodiment, an effect of reducing an advertiser's burden is obtained.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A delivery device, comprising:
a providing unit configured to provide a sales service related to a space of second content provided together with first content in a facility providing the first content; and
a delivering unit configured to deliver associated information in which the second content corresponding to a right holder that has acquired a right related to the space in the sales service provided by the providing unit is associated with space information related to the space to the facility.

2. The delivery device according to claim 1, further comprising,
an acquiring unit configured to acquire the information related to the space from the facility,
wherein the providing unit provides the sales service related to the space based on the information related to the space acquired by the acquiring unit.

3. The delivery device according to claim 2,
wherein the providing unit provides a sales service related to a space set by the facility based on the information related to the space acquired by the acquiring unit.

4. The delivery device according to claim 2,
wherein the providing unit sets a space of a sales target based on the information related to the space acquired by the acquiring unit, and provides a sales service related to the set space.

5. The delivery device according to claim 2,
wherein the providing unit provides a sales service related to a space designated by a purchaser based on the information related to the space acquired by the acquiring unit.

6. The delivery device according to claim 2,
wherein the acquiring unit acquires information related to the space transmitted by facility based on a schedule in which the first content is provided.

7. The delivery device according to claim 2,
wherein the acquiring unit acquires information related to the space transmitted by the facility according to a sales situation of the space in the facility.

8. The delivery device according to claim 1,
wherein the providing unit provides a sales service in which a sales price varies according to a sales period of a right related to the space.

9. The delivery device according to claim 1,
wherein the providing unit causes a provision condition for providing the second content to be designated, and provides a sales service related to the space satisfying the designated provision condition, and
the delivering unit delivers associated information in which the second content corresponding to the right holder is associated with space information related to the space satisfying the provision condition designated by the right holder.

10. The delivery device according to claim 9,
wherein the providing unit causes a condition related to the facility to be designated as the provision condition, and provides the sales service.

11. The delivery device according to claim 10,
wherein the providing unit causes at least one of information related to the facility and information related to an audience in the facility to be designated as the condition related to the facility, and provides the sales service.

12. The delivery device according to claim 11,
wherein the providing unit causes at least one of a region in which the facility is located, a schedule in which the first content is provided in the facility, a capacity of the facility, a tendency or a genre of the first content provided in the facility, an operating company operating the facility, and a number by which the first content is able to be simultaneously provided in the facility to be designated as the information related to the facility, and provides the sales service.

13. The delivery device according to claim 11,
wherein the providing unit causes at least one of an attendance record of an audience in the facility, a current attendance of an audience in the facility, and an attribute of an audience in the facility to be designated as information related to an audience in the facility, and provides the sales service.

14. The delivery device according to claim 9,
wherein the providing unit causes a condition related to the first content to be designated as the provision condition, and provides the sales service.

15. The delivery device according to claim 14,
wherein the providing unit causes at least one of information related to a creator of the first content and information related to content of the first content to be designated as the condition related to the first content, and provides the sales service.

16. The delivery device according to claim 15,
wherein the providing unit causes a creator, a director, or a distribution company of the first content, nationality of the creator, or a mobilization record of the creator to be designated as information related to the creator of the first content, and provides the sales service.

17. The delivery device according to claim 15,
wherein the providing unit causes a genre, a title, or a cast of the first content to be designated as the information related to the content of the first content, and provides the sales service.

18. The delivery device according to claim 1,
wherein the delivering unit selects the second content to be delivered to the facility based on a reputation on an arbitrary content delivered for use in a web site.

19. The delivery device according to claim 18,
wherein the delivering unit selects the second content to be delivered to the facility based on a reputation on the second content delivered for use in the web site as the arbitrary content.

20. The delivery device according to claim 1,
wherein the providing unit presents a predictive value of an attendance of the facility, and provides the sales service.

21. The delivery device according to claim 1, further comprising,
a converting unit configured to convert the second content corresponding to the right holder into a format providable in facility,
wherein the delivering unit delivers associated information in which the second content converted by the converting unit is associated with the space information.

22. A delivery method executed by a computer, comprising:
providing a sales service related to a space of second content provided together with first content in a facility providing the first content; and
delivering associated information in which the second content corresponding to a right holder that has acquired a right related to the space in the sales service provided in the providing is associated with space information related to the space to the facility.

23. A non-transitory computer readable storage medium containing program instructions for a delivery program instruction by one or more processors of a computer to perform:
providing a sales service related to a space of second content provided together with first content in a facility providing the first content; and
delivering associated information in which the second content corresponding to a right holder that has acquired a right related to the space in the sales service provided in the providing is associated with space information related to the space to the facility.

24. A facility device, comprising:
a transmission unit configured to transmit information related to a space of second content provided with first content to a delivery device providing a sales service related to the space; and
a reception unit configured to receive associated information in which the second content corresponding to a right holder that has acquired a right related to the space is associated with space information related to the space from the delivery device that has received the information related to the space.

25. A delivery system, comprising:
a delivery device; and
a facility device used in a facility,
wherein the delivery device comprises
a providing unit configured to provide a sales service related to a space of second content provided together with first content in a facility providing the first content, and
a delivering unit configured to deliver associated information in which the second content corresponding to a right holder that has acquired a right related to the space in the sales service provided by the providing unit is associated with space information related to the space to the facility, and
the facility device comprises
a transmission unit configured to transmit the information related to the space to the delivery device, and
a reception unit configured to receive the associated information from the delivery device.
